(19) United States
(12) Patent Application Publication
(10) Pub. No.: US 2026/0005269 A1
(43) Pub. Date: Jan. 1, 2026

(54) SEMIPERMEABLE MEMBRANE FOR MEMBRANE HUMIDIFIER

(71) Applicant: HENGST SE, Muenster (DE)

(72) Inventors: Niels TANNERT, Muenster (DE); Mathias DIEKJAKOBS, Steinfurt (DE); Mark VON LUETZAU, Muenster (DE)

(21) Appl. No.: 19/104,435

(22) PCT Filed: Aug. 16, 2023
(86) PCT No.: PCT/EP2023/072537

§ 371 Date: Feb. 18, 2025

(30) Foreign Application Priority Data
Aug. 31, 2022 (DE) 102022122003.6

(51) Int. Cl. H01M 8/04119; B01D 67/00; B01D 69/10; B01D 69/12; B01D 71/70; H01M 8/10

(52) U.S. Cl. CPC H01M 8/04149; B01D 67/00091; B01D 69/107; B01D 69/1214; B01D 71/70; H01M 2008/1095

(57) ABSTRACT

The invention relates to a semipermeable membrane (10), in particular for use in membrane humidifiers for fuel cell systems, comprising: a) a support layer (12) comprising a composite material comprising at least one plastic and at least one silicon-containing porous filler embedded in the plastic, and b) a cover layer (14) arranged on the support layer (12) and comprising at least one organosilicon compound.

The invention relates to a semipermeable membrane and a membrane humidifier comprising a corresponding semipermeable membrane, a fuel cell system comprising a corresponding membrane humidifier and a method for producing a corresponding semipermeable membrane.

For some years now, the use of fuel cells in the field of vehicle technology has been seen as a promising way of reducing dependence on fossil fuels such as crude oil. The fuel cell is one of the most important alternatives to the use of batteries, such as lithium-ion batteries. Compared to battery technology, fuel cell technology has specific advantages, particularly with regard to the practical handling of a fuel compared to electrochemical storage, the storage potential and the potentially short refilling times of the fuel, which can avoid long charging times, as well as the potential possibility of using the existing line and storage infrastructure of the classic fuel supply instead of having to build a battery charging infrastructure. These advantages are particularly important for use in areas where lengthy charging processes need to be avoided, especially in the aviation sector and in heavily used commercial vehicle fleets.

In fuel cells, the conversion of oxygen with a fuel, for example hydrogen, methane or methanol, to water and possibly other reaction products takes place under controlled reaction conditions, whereby the reaction steps of the redox reaction are spatially separated. For this purpose, the fuel cell consists of an anode and a cathode, which are separated from each other by an electrolyte, for example an electrolyte membrane

The reactants are usually fed continuously to the fuel cell during operation. During operation, fuel cells, in particular polymer electrolyte membrane fuel cells (PEM fuel cells), place high demands on the purity of the process gases used and on the setting of the optimum humidity to prevent the electrolyte membrane from drying out even at high operating temperatures. This regularly requires complex management and control of the fluid flows and the use of high-performance filter technology.

In order to ensure sufficient humidification of the electrolyte membrane even at high operating temperatures, it is advantageous in principle to humidify the supplied process gas, in particular the process gas on the cathode side. This moisture can be supplied to the process gas from a reservoir, for example humid air, via a suitable humidification device. Since water is formed during operation of the fuel cell, the exhaust air from the fuel cell can also serve as a reservoir for the moisture, for example. During humidification, the aim is regularly to ensure that, apart from the exchange of moisture, there is no or at least only minimal contact between the process gas and the reservoir, so that, for example, contamination of the process gas with the exhaust air can be avoided.

Theoretically, various humidifiers can be used as humidification devices. However, so-called membrane humidifiers, in which one or more moisture-permeable membranes are used, for example a hollow fiber membrane that is permeable to water vapor but largely prevents any further exchange of substances, are regularly regarded as a particularly efficient and advantageous form of humidification device.

If a humid and a dry gas flow are separated by such a semi-permeable membrane, a diffusion-driven passage of water from the humid gas flow to the dry gas flow takes place as a result of the different partial pressures of the water in the two gas flows.

PEM fuel cell systems, their design and the use of membrane humidifiers in these PEM fuel cell systems are comprehensively known to the skilled person from the prior art and are described, for example in DE 102015202089 A1, DE 102015224202 A1 or DE 102016224478 A1.

While a slight passage of other components of the reservoir fluid, i.e. in addition to the desired moisture passage, is usually considered unproblematic for applications in the field of building air management, for example, it is regularly desired for applications in the field of fuel cells that a mixing of the supply and exhaust air flows that goes beyond the moisture exchange can be prevented as reliably as possible. In addition to structural aspects of membrane humidifiers, this is usually determined to a large extent by the properties of the membranes used, so that there is a constant need to further improve these membranes.

In the field of building air management, membrane humidifiers have been proposed that use a semi-permeable membrane as a water transport membrane, which comprises a porous polyethylene substrate loaded with silicon dioxide, which has a coating on the surface that comprises a cross-linked, water-permeable, non-ionic polyurethane-polyether polymer, as disclosed in EP 2435171 B1. According to EP 2435171 B1, these water transport membranes allow a high passage of water (vapor and liquid), but at the same time show only a low or even no passage of gas and impurities.

The inventors have tested the water transport membranes known from the field of building air management from EP 2435171 B1 and evaluated their performance for use in membrane humidifiers for fuel cells. It was found that the water transport membranes known from the prior art could not sufficiently fulfill the application-specific requirements in all areas, whereby the inventors suspect at least in part an influence of the higher temperatures compared to building air management and/or the air humidities occurring in practice in the exhaust air flow of fuel cells. In addition to the achievable water permeation and the observed breakthrough of exhaust air or impurities under process conditions, the durability of the water transport membranes in fuel cell systems in particular was found to be insufficient, especially at elevated temperatures or high humidities, to ensure sufficient durability, especially under the mechanical loads to be expected in vehicle use. This durability, which the inventors consider inadequate for fuel cell applications, primarily concerns the bond strength between the substrate and the coating of the polyurethane-polyether polymer, whereby this effect of possible detachment of the coating during prolonged exposure in a warm and humid environment, which may be acceptable for applications in building air management, is, according to the inventors' assessment, already clearly documented in EP 2435171 B1 (see paragraph [0063]).

The primary task of the present invention was to eliminate or at least mitigate the disadvantages of the prior art described above.

In particular, it was a task of the present invention to specify a semi-permeable membrane which has excellent water permeability and at the same time prevents the passage of air and other impurities through the membrane as far as possible. At the same time, the semipermeable membrane to be disclosed should have a high mechanical strength and improved durability compared to the prior art, in particular at elevated temperatures or high humidity. In addition, the semi-permeable membrane to be disclosed should be as time-and cost-efficient as possible to manufacture, and it should preferably be possible to use as few materials as possible that are harmful to health and/or the environment during manufacture, in particular without the use of perfluorine compounds.

It was an additional task of the present invention to provide a method for producing corresponding semi-permeable membranes.

It was a secondary task of the present invention to provide an efficient membrane humidifier for use in fuel cell systems and a corresponding fuel cell system.

The inventors of the present invention have now realized that the tasks described above can surprisingly be solved by a semipermeable membrane comprising a support layer comprising a specific composite material and a cover layer comprising an organosilicon compound disposed on the support layer, as defined in the claims, as defined in the claims, whereby a semipermeable membrane is obtained which is advantageously also excellently suited for numerous other applications in which a moisture and/or enthalpy transfer from a moist compartment to a drier compartment is required.

The above-mentioned tasks are thus solved by the object of the invention as defined in the claims. Preferred embodiments according to the invention result from the subclaims and the following explanations.

In particularly preferred embodiments, such embodiments designated as preferred below are combined with features of other embodiments designated as preferred. Combinations of two or more of the embodiments described below as particularly preferred are thus particularly preferred. Also preferred are embodiments in which a feature of an embodiment designated as preferred to any extent is combined with one or more further features of other embodiments designated as preferred to any extent. Features of preferred membrane humidifiers, methods and fuel cell systems are derived from the features of preferred semipermeable membranes.

The invention relates in particular to a semipermeable membrane, especially for use in membrane humidifiers for fuel cell systems, comprising:
a) a support layer comprising a composite material, comprising at least one plastic and at least one silicon-containing porous filler embedded in the plastic, and
b) a cover layer arranged on the support layer, comprising at least one organosilicon compound.

The semipermeable membranes according to the invention are particularly suitable for being installed in a membrane humidifier and used in this form in a fuel cell system, in particular in the fluid conduction system. The suitability results in particular from the advantageous specific properties of the semipermeable membranes according to the invention, in particular with regard to the excellent durability even at elevated temperatures of 80° C. or more, or the resulting increased air humidities which occur in the exhaust air flow of fuel cell systems. Furthermore, due to their advantageous water permeability and the reliable suppression of the passage of air and other impurities, the semipermeable membranes according to the invention are also excellently suited for other applications, for example in modules for the transfer of moisture and/or enthalpy from a gas with a high partial pressure of water into a drier gas.

Compared to the prior art, as disclosed for example in EP 2435171 B1, the advantageous properties, in particular the good resistance and the excellent bond strength between the layers, are achieved even without additional chemical crosslinking. In addition, the favorable transport properties are achieved without the need for additional processing steps after coating, especially in comparison with PVA-based coatings, whereby in particular no deliberate defects in the top layer or deliberate detachments have to be produced, so that in the production of semipermeable membranes according to the invention, a continuous, highly functional and durable cover layer can be obtained with just one coating step and one coating center.

In accordance with the skilled person's understanding, the term “semipermeable” means that the semipermeable membrane according to the invention does not have the same permeability for all substances, whereby the permeability for individual molecules and substances, possibly depending on their aggregate state and/or their particle form, can also be so low that essentially no passage of these components can take place through the semipermeable membrane. The person skilled in the art understands that the semipermeable membrane according to the invention is a water transport membrane which is accordingly permeable at least to gaseous water, preferably to gaseous and condensed water. In other words, it is thus a semipermeable membrane according to the invention, wherein the semipermeable membrane is permeable to water.

Since the task of the semipermeable membrane according to the invention is also to prevent the passage of other components, in particular air and other gases, as well as particulate impurities, in addition to the transport of water, the permeability of the semipermeable membrane according to the invention is reduced for these components. A semipermeable membrane according to the invention is preferred, wherein the semipermeable membrane shows an air permeability of 2.0 cm³/(cm² min) or less, preferably of 1.0 cm³/(cm² min) or less, preferably of 0.5 cm³/(cm² min) or less, as a result of a pressure difference of 20 kPa applied between the lateral surfaces of the semipermeable membrane. A semipermeable membrane according to the invention is particularly preferred, wherein the semipermeable membrane is essentially impermeable to air, wherein the semipermeable membrane is essentially impermeable in particular to oxygen, nitrogen, carbon dioxide and mixtures of these gases. Accordingly, a semipermeable membrane which is essentially impermeable to particulate impurities is also particularly preferred.

In accordance with professional understanding, a membrane is a thin, flat structure whose extension in the XY plane is significantly greater than its extension in the Z direction, i.e. a flat structure whose length and width are significantly greater than its thickness.

The semipermeable membrane according to the invention comprises a support layer. This support layer comprises a composite material. In accordance with the understanding in the art, a composite material is a material which consists of two or more components which are bonded together, and which together result in a material which has different physico-chemical properties than the isolated components. Such composite materials are sometimes also referred to as composites.

According to the invention, the support layer comprises the composite material, so that the support layer can also be formed at least partially by other materials. However, the person skilled in the art understands that it is preferred if the support layer is not only partially made of the composite material, but is at least predominantly or, preferably, substantially entirely made of the composite material. In the opinion of the inventors, an embodiment in which the support layer is formed essentially entirely from the composite material is preferred for essentially all applications.

The composite material itself is formed from at least one plastic and at least one silicon-containing porous filler, which is embedded in the plastic so that the silicon-containing porous filler is at least partially dispersed in the plastic. A semipermeable membrane according to the invention is relevant for almost all embodiments, wherein the silicon-containing porous filler is present in the composite material in a plurality of particles dispersed in the plastic. Even if an inhomogeneous distribution of the silicon-containing porous filler in the plastic matrix would be conceivable, a semipermeable membrane according to the invention is preferred, wherein the silicon-containing porous filler in the composite material is essentially evenly distributed in the plastic.

The plastic that forms the carrier matrix for the embedded silicon-containing porous filler in the composite material can, in principle, be any conventional polymer material, since the chemical nature of the plastic matrix itself is not decisive for the application-relevant properties and the choice of plastic in practice will probably be based primarily on the desired mechanical properties

According to the invention, the filler associated with the plastic is silicon-containing. In accordance with the understanding of the skilled person, this means that the filler consists of a chemical compound comprising silicon atoms in its molecular and/or crystal structure.

However, the filler used in the composite material not only contains silicon, but is also porous, which means that the ratio of the volume of the cavities inside the porous filler to the total volume of the porous filler is greater than zero, which means that the porous filler or the particles of the porous filler have cavities inside which can be connected to each other. The so-called open porosity or useful porosity results from the combined volume of the cavities that are connected to each other and to the environment, whereby the skilled person understands that for the silicon-containing porous fillers to be used according to the invention, the porosity should at least partially be an open porosity, as is the case, for example, with many zeolite materials but also with numerous industrially used fillers made of amorphous silicon dioxide (sometimes also referred to as “silica”). A semipermeable membrane according to the invention is relevant for almost all embodiments, wherein the silicon-containing porous filler is microporous and/or mesoporous and/or macroporous. A preferred semipermeable membrane according to the invention is one in which the silicon-containing porous filler is mesoporous and/or macroporous, wherein the silicon-containing porous filler is particularly preferably designed as a hierarchically porous filler, i.e. has a hierarchically structured pore system in which, for example, mesopores are located at the edges of macropores.

The person skilled in the art understands that the porosity of the silicon-containing porous filler causes or promotes a porosity of the composite material, which in turn causes or promotes water permeability. A semipermeable membrane according to the invention is therefore relevant for almost all embodiments, wherein the composite material is a porous composite material, preferably a microporous composite material. A semipermeable membrane according to the invention is preferred, wherein the composite material has a porosity in the range from 30 to 90%, preferably in the range from 40 to 80%, particularly preferably in the range from 50 to 60%.

In addition to the support layer, the semipermeable membrane according to the invention also comprises a cover layer. This cover layer is arranged on the support layer and covers it at least partially, so that the cover layer can be understood as a coating of the support layer. Unlike in the prior art, this cover layer comprises at least one organosilicon compound. In accordance with the understanding in the art, organosilicon compounds, which are also referred to as organosilicon compounds, are compounds that comprise at least silicon and carbon atoms, wherein the carbon can be bonded to the silicon either directly or via a heteroatom, in particular oxygen, as is the case, for example, in siloxanes and polysiloxanes. Corresponding starting materials that are suitable for the production of cover layers are commercially available from numerous manufacturers, for example from the companies Evonik, Hubei or Wacker Chemie, although some of them are offered for other purposes, for example as adhesion promoters. Examples of commercial products include products from Evonik, which are sold under the trade name Dynasylan, for example in the versions SIVO 110, SIVO 418, SIVO 850, VPS SIVO 608, Hydrosil 2909 or Triamo.

Even if it is possible in principle to use further layers in semipermeable membranes according to the invention, it is preferable in most cases, in view of the performance properties and the achievable thickness of the membranes, to form the semipermeable membrane according to the invention only from the two layers described above. Accordingly, a semipermeable membrane according to the invention is preferred, wherein the semipermeable membrane consists of the support layer and the cover layer.

As explained above, the composite material can comprise a wide range of possible plastics, so that the skilled person can select the plastic used with particular regard to the mechanical requirements placed on the semipermeable membrane and the available materials. However, the inventors have succeeded in this respect in identifying plastics which are particularly suitable for use in semipermeable membranes according to the invention due to their processing properties and mechanical properties. A semipermeable membrane according to the invention is preferred, wherein the plastic is selected from the group consisting of thermoplastics, preferably selected from the group consisting of polyvinyl chlorides and polyolefins, particularly preferably selected from the group consisting of polyolefins, in particular polyethylene and polypropylene, wherein the plastic is particularly preferably a polyethylene, in particular an ultra-high molecular weight polyethylene.

In the same way, the inventors have succeeded in identifying particularly advantageous silicon-containing porous fillers with which composite materials can be obtained which are particularly advantageous when used in semipermeable membranes according to the invention. These silicon-containing porous fillers can be regularly dispersed particularly well in conventional plastics, are available with suitable porosities and show an advantageous interaction with the organosilicon compounds of the cover layer. A semipermeable membrane according to the invention is preferred, wherein the silicon-containing porous filler is selected from the group consisting of silicon-aluminum-phosphorus-oxygen compounds, silicon-containing organometallic framework compounds, zeolites and amorphous silicon dioxide, preferably selected from the group consisting of amorphous silicon dioxide, preferably selected from the group consisting of zeolites and amorphous silica, particularly preferably selected from the group consisting of amorphous silica, in particular aerogels, precipitated silica and fumed silica, most preferably selected from the group consisting of aerogels and precipitated silica, in particular precipitated silica.

The person skilled in the art understands that silicon-containing porous fillers, in particular the silicon-containing porous fillers described above as preferred, are regularly hygroscopic and can therefore also make a contribution beyond the porosity to water being able to pass through the composite material, or that the composite material has an advantageously high absorption capacity for water. A semipermeable membrane according to the invention is correspondingly relevant for almost all embodiments, wherein the silicon-containing porous filler is a desiccant.

In this respect, the inventors have succeeded in identifying particularly advantageous mass fractions in the composite material for the two above-mentioned components of the composite material. A semipermeable membrane according to the invention is preferred, wherein the combined mass fraction of the silicon-containing porous fillers in the composite material is in the range from 25 to 85%, preferably in the range from 45 to 80%, particularly preferably in the range from 60 to 75%, relative to the mass of the composite material. Additionally or alternatively, a semipermeable membrane according to the invention is also preferred, wherein the combined mass fraction of the plastics in the composite material is in the range from 15 to 75%, preferably in the range from 20 to 55%, particularly preferably in the range from 25 to 40%, based on the mass of the composite material.

The inventors have also succeeded in identifying particularly suitable compounds for the organosilicon compounds, with which particularly efficient semipermeable membranes according to the invention can be obtained, in particular with regard to an advantageous water permeability, and which in particular have a high compatibility with the preferred silicon-containing porous fillers defined above. Preferred is namely a semipermeable membrane according to the invention, wherein the organosilicon compound is selected from the group consisting of silyl ethers, silanes, siloxanes and polysiloxanes, preferably selected from the group consisting of silyl ethers, siloxanes and polysiloxanes, more preferably selected from the group consisting of siloxanes and polysiloxanes, most preferably selected from the group consisting of siloxanes and polysiloxanes.

The person skilled in the art understands in this respect that, although other compounds may potentially be present in the covering layer in addition to the organosilicon compounds to be provided according to the invention, for example binders, it is preferred if the covering layer consists as far as possible of the organosilicon compounds. Accordingly, a semipermeable membrane according to the invention is preferred, wherein the combined mass fraction of the organosilicon compounds in the cover layer is in the range from 50 to 100%, preferably in the range from 70 to 100%, particularly preferably in the range from 90 to 100%, very particularly preferably in the range from 95 to 100%, relative to the mass of the cover layer, wherein the cover layer preferably consists essentially entirely of the organosilicon compounds.

Furthermore, it may be preferable for certain applications if the cover layer also comprises one or more additives in order to adapt the physico-chemical properties of the cover layer precisely to the respective requirements of the application. In particular, the use of antioxidants to increase ageing resistance is conceivable. In addition, the topcoat can, for example, be specifically modified physico-chemically in order to increase properties such as water wettability, oxidative and/or mechanical stability, selectivity or permeability or to reduce susceptibility to fouling. This can be achieved, for example, by using ionizing radiation, such as electron, ion or gamma radiation, or by introducing suitable organic or inorganic components. Even if the semipermeable membranes according to the invention advantageously exhibit high resistance even without separate crosslinking, it can be useful, particularly for mechanically demanding applications, to additionally chemically crosslink the cover layer, for example by means of thermal or radiation-induced crosslinking, whereby crosslinkers and/or corresponding initiators can be added to the cover layer as additives for this purpose. In addition, coupling agents can also be considered as additives, for example, which can serve to further improve the bonding of the cover layer to the support layer.

Since semipermeable membranes according to the invention have a high resistance to the passage of air and other impurities, it is advantageously possible to design semipermeable membranes according to the invention to be particularly thin without introducing impurities to an undesirable extent into the gas stream to be humidified. Since the design as a thin membrane is also particularly favorable with regard to water permeability and with regard to material requirements and manufacturing costs, it is correspondingly expedient to use the favorable properties of semipermeable membranes according to the invention by making them particularly thin. It can be seen as an advantage of the semipermeable membranes according to the invention that the advantageous properties with regard to the passage of air and other foreign particles through the semipermeable membrane with the specific cover layer can already be achieved if the latter is made relatively thin. Since a thin cover layer in turn results in material savings and increased water permeability, the inventors believe that it is also particularly advantageous to make the cover layer as thin as possible. In this respect, a semipermeable membrane according to the invention is preferred, wherein the cover layer has an average thickness in the range from 0.1 to 10 μm, preferably in the range from 0.5 to 8 μm, particularly preferably in the range from 1 to 5 μm. Preferred is additionally or alternatively a semipermeable membrane according to the invention, wherein the support layer has an average thickness in the range from 10 to 500 μm, preferably in the range from 20 to 250 μm, particularly preferably in the range from 40 to 190 μm, most preferably in the range from 80 to 160 μm.

In this context, the inventors have also identified suitable basis weights for coating the support layer with the cover layer. In fact, a semipermeable membrane according to the invention is preferred, wherein the grammage of the cover layer is in the range from 0.25 to 15 g/m², preferably in the range from 0.5 to 5 g/m².

The performance of the specific cover layer in terms of preventing the passage of air and other unwanted impurities also makes it advantageously possible to select an asymmetrical structure for the semipermeable membrane, in which only one cover layer is provided, which is accordingly only applied to one side of the support layer, so that it is not necessary to provide the support layer with a cover layer on both sides, so that material and weight savings and simpler production are possible. A semipermeable membrane according to the invention is therefore preferred, whereby a cover layer is only arranged on one side of the carrier layer.

Even if, as explained above, it is possible and expedient to cover only one side of the support layer with the cover layer, it is, however, in the opinion of the inventors, expedient with regard to the intended application to cover the support layer with the cover layer on one side as completely as possible so that no partial areas of the semipermeable membrane are formed which are excessively permeable to air or unwanted contamination. A preferred semipermeable membrane according to the invention is one in which the support layer is covered on one side by more than 60%, preferably more than 75%, particularly preferably more than 90%, most preferably essentially completely by the cover layer. Especially when a low coverage of the support layer by the cover layer is chosen, it can be advantageous to provide the uncovered parts of the surface with a sealing coating instead, i.e. a coating that is impermeable to both air and water.

To further avoid unintentionally permeable sections of the semipermeable membrane, it is also preferred to use a coating that is as uniform as possible. Accordingly, a semipermeable membrane according to the invention is preferred, wherein the thickness of the cover layer varies by 50% or less, preferably 25% or less, particularly preferably 10% or less, highly preferably 5% or less, over the entire area of the support layer covered by the cover layer.

According to the inventors, a particular advantage of semipermeable membranes according to the invention is that particularly advantageous bond strengths can be achieved between the cover layer and the support layer, which contribute to a long durability of semipermeable membranes according to the invention, even at elevated temperatures and high humidity. According to the inventors, this effect is particularly pronounced if there is at least partial covalent application of the organosilicon compounds of the cover layer to the composite material, this bonding taking place expediently on the silicon-containing porous filler of the composite material, which is also present on the surface of the support layer as a result of an essentially homogeneous distribution in the plastic matrix. Such a covalent bond can be achieved by a chemically and/or thermally induced reaction of the organosilicon compound with the silicon-containing porous filler, whereby the use of so-called “cross-linking agents” may be necessary to promote the covalent bond. It is particularly advantageous here that the silicon-containing porous fillers, which are present on the surface of the composite material, can provide a large inner surface area due to their high porosity, which is available for the bonding of the organosilicon compound. A semipermeable membrane according to the invention is particularly preferred, wherein at least some of the organosilicon compounds of the cover layer are covalently bound to the silicon-containing porous filler of the composite material.

In particularly preferred embodiments, the organosilicon compound is covalently bonded to the silicon-containing porous filler by a condensation reaction between an Si—O—R group, where R denotes hydrogen or an organic radical, of the organosilicon compound with a silanol group which is present on the surface of the silicon-containing porous fillers, as is the case, for example, on the surface of amorphous silica. Preferred for this purpose is a semipermeable membrane according to the invention, wherein the organosilicon compound is selected from the group consisting of an organosilicon compound having at least one Si—O—R group, wherein R is hydrogen or an organic radical, preferably an alkyl radical, particularly preferably an alkyl radical having 1 to 10 carbon atoms. Preferred in this respect is additionally or alternatively a semipermeable membrane according to the invention, wherein the silicon-containing porous filler comprises Si—O—H groups on the surface.

In other words, a semipermeable membrane according to the invention is preferred, wherein the cover layer can be produced by coating the support layer with one or more organosilicon compounds selected from the group consisting of organosilicon compounds having at least one Si—O—R group, wherein R is hydrogen or an organic radical, preferably an alkyl radical, particularly preferably an alkyl radical having 1 to 10 carbon atoms.

While in many cases undesirable delamination of the cover layer is observed in semipermeable membranes as a result of mechanical stress, which has a detrimental effect on the performance and can even call into question the fundamental suitability in sensitive fuel cell systems, the advantageous composite strength of the semipermeable membranes according to the invention, in particular if at least partial covalent bonding occurs, even allows the semipermeable membranes according to the invention to be folded, based on experiments by the inventors. In this way, great advantages can be achieved in terms of space utilization and the effectively available surface area, which makes the semipermeable membranes according to the invention particularly suitable for use in fuel cell systems. Accordingly, a semipermeable membrane according to the invention is also preferred, wherein the semipermeable membrane is folded, preferably in a flat pleat arrangement, as is known, for example, from flat pleat filters.

In the opinion of the inventors, a semipermeable membrane for use in membrane humidifiers for fuel cell systems is particularly preferred, comprising:
aa) a support layer comprising a composite material, comprising at least one plastic and at least one silicon-containing porous filler embedded in the plastic, wherein the silicon-containing porous filler is selected from the group consisting of zeolites and amorphous silica, in particular amorphous silica, wherein the combined mass fraction of the plastics in the composite material is in the range from 15 to 75%, wherein the combined mass fraction of the silicon-containing porous fillers in the composite material is in the range from 25 to 85%, in each case based on the mass of the composite material, and
bb) a cover layer arranged on the support layer, comprising at least one organosilicon compound, wherein the organosilicon compound is selected from the group consisting of siloxanes and polysiloxanes, wherein the combined mass fraction of the organosilicon compounds in the cover layer is in the range from 50 to 100%, based on the mass of the cover layer.

The skilled person will further understand that the invention also relates to a membrane humidifier, in particular for use in fuel cell systems, comprising at least one, preferably two or more, semipermeable membranes according to the invention.

The invention also relates to a fuel cell system, in particular a polymer electrolyte membrane fuel cell system, comprising at least one fuel cell and at least one membrane humidifier according to the invention.

In this case, the membrane humidifier according to the invention is arranged in the fluid line system of the fuel cell, preferably in the cathode-side fluid line system. The membrane humidifier is preferably arranged in such a way that it is arranged simultaneously in the fluid supply line and the fluid discharge line, so that the supplied process gas and the discharged process gas can flow through it in such a way that the supplied process gas and the discharged process gas are separated from one another in sections by the semipermeable membrane according to the invention.

The invention also relates to a method of manufacturing a semipermeable membrane according to the invention, comprising the process steps:
u) Producing or providing a support layer of a composite material comprising at least one plastic and at least one silicon-containing porous filler embedded in the plastic,
v) applying a coating composition comprising at least one organosilicon compound and at least one solvent onto the surface of the support layer, and
w) evaporating the solvent to obtain a cover layer arranged on the support layer, comprising at least one organosilicon compound.

A preferred method according to the invention is one in which the support layer is produced by extrusion of a plastic mixture comprising the silicon-containing porous filler, preferably using an extruder.

With regard to the achievable quality of the coating, in particular in the case of a partial covalent bonding of the cover layer to the support layer, a process according to the invention is preferred, wherein the evaporation of the solvent takes place at a temperature in the range from 40 to 120° C., preferably in the range from 50 to 100° C., particularly preferably in the range from 60 to 90° C. A method according to the invention is thus also preferred, wherein the evaporation of the solvent takes place in such a way that at least some of the organosilicon compounds of the cover layer are covalently bonded to the silicon-containing porous filler of the composite material.

With a view to efficient process control, a method according to the invention is preferred, wherein the solvent is selected from the group consisting of water, alcohols, in particular methanol, ethanol and iso-propanol, aqueous acids, aqueous bases and mixtures of these solvents, in particular from the group consisting of water, aqueous bases, in particular aqueous solutions of alcoholates or hydroxides, and mixtures of these solvents, wherein the solvent preferably comprises water, alcohol and a base.

In the following, the invention and preferred embodiments of the invention are explained and described in more detail with reference to the accompanying figures. The figures show:

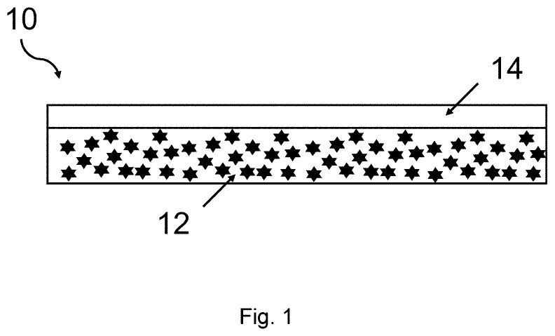

FIG. 1 a schematic cross-sectional view of a semipermeable membrane according to the invention in a preferred embodiment;

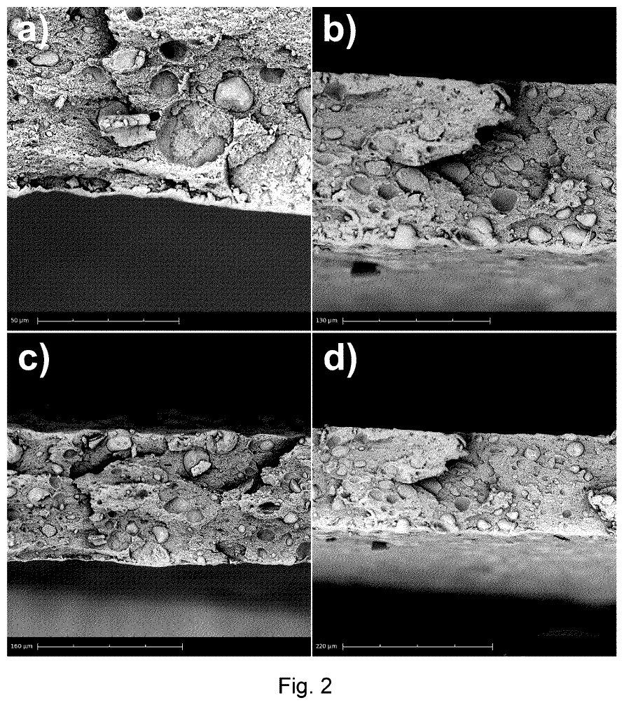

FIG. 2 Four scanning electron microscope cross-sectional images through semipermeable membranes according to the invention after ten days of storage in boiling water; and

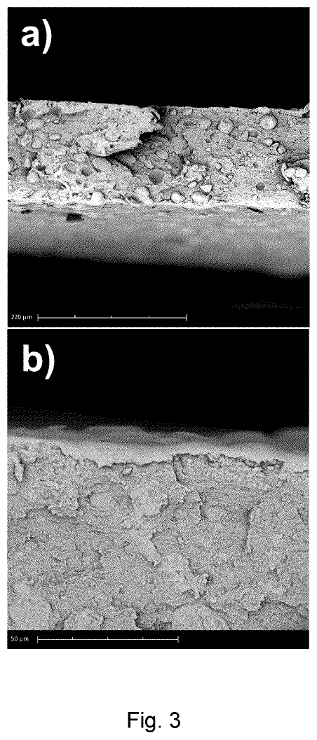

FIG. 3 Two scanning electron microscope cross-sectional images through semipermeable membranes according to the invention after ten days of storage in a drying oven at 105° C.

FIG. 1 shows a schematic cross-sectional representation of a semipermeable membrane 10 according to the invention in a preferred embodiment. The exemplary semipermeable membrane 10 is intended for use in a membrane humidifier, which in turn is used in a polymer electrolyte membrane fuel cell system. The semipermeable membrane 10 of FIG. 1 comprises a support layer 12 and a cover layer 14, which is arranged on one side of the support layer 12 and essentially completely covers the surface of the support layer 12 on this side. The support layer 12 is formed entirely from a composite material comprising polyethylene as a plastic matrix in which porous amorphous silicon dioxide, namely precipitated silicon dioxide, is substantially uniformly dispersed. The support layer 12 has a substantially constant thickness of approximately 120 μm, whereas the cover layer 14 has a substantially constant thickness of approximately 3 μm.

The presence of the silicon-containing porous filler in the plastic matrix of the composite material is visualized in FIG. 1 by the stars indicated in the support layer 12.

The resulting semipermeable membrane 10 of FIG. 1 is permeable to water, but largely impermeable to air, to the extent that the semipermeable membrane 10 can be regarded as essentially impermeable to air according to the standards relevant in practical application.

The silicon-containing porous filler has mesopores and macropores, so that the composite material is itself a meso-and macroporous material due to the embedded porous filler. In the composite material of the carrier layer 12, the mass fraction of the silicon-containing porous filler is about 65%, while the remaining mass fraction is formed by the polyethylene.

In the example shown, the top layer 14 consists essentially entirely of a polysiloxane, which has Si—O—R groups (R═H or alkyl) and is at least partially covalently bonded to the silicon-containing porous filler of the composite material, namely by reaction of the Si—O—R groups with the silanol groups located on the surface of the filler particles.

A corresponding semipermeable membrane 10 can be produced starting from a support layer 12, the composite material of which consists of the plastic and the silicon-containing porous filler and which can be produced, for example, by extrusion of a plastic mixture comprising these two components. A coating composition containing the organosilicon compounds and at least one solvent, for example an aqueous solution of alkolates, which can be prepared by mixing water, alcohol and a base, is then applied to the support layer 12. The formation of the cover layer 14 arranged on the support layer 12 then takes place at elevated temperatures of for example 80° C. by evaporation of the solvent, whereby the conditions in this process step are preferably set such that the covalent bonding of the organosilicon compound of the cover layer 12 with the silicon-containing porous filler of the support layer 14 is promoted.

FIGS. 2 and 3 each show cross-sectional scanning electron micrographs through semipermeable membranes according to the invention (see below for details of manufacture) after different ageing conditions, namely for FIG. 2 after ten days' storage in moving, boiling water (100° C.) and for FIG. 3 after ten days' storage in a drying oven at 105° C. To obtain the fracture edges shown and to ensure representative images, the samples were immersed in liquid nitrogen and measured with a scanning electron microscope (SEM) immediately after the temperature-induced fracture (“cryogenic breaking”). The SEM images clearly show the structure of the composite material in the carrier layer, in whose polyolefin carrier matrix particulate porous amorphous silicon dioxide is clearly dispersed. All SEM images show that the respective cover layer, which is arranged below the support layer in FIG. 2 and above it in FIG. 3, is not only clearly recognizable despite the ageing tests, which were aligned with the loads to be expected in a fuel cell, but also that a continuous coating without defects has essentially been preserved.

In the following, the invention and preferred embodiments of the invention are further explained and described with reference to experiments.

### A. Production of Semipermeable Membranes According to the Invention

Four semipermeable membranes E1 to E4 according to the invention were produced. For this purpose, a support layer made of composite material was provided, which is commercially available under the name Teslin SP600 from the company PPG Industries. The support layer consists of a support matrix made of polyolefin in which particulate porous amorphous silicon dioxide is dispersed. The support layer had an average thickness of about 150 μm and an average basis weight of about 97 g/m².

The cover layer was applied to the support layer by coating with an Easycoater coating device from Coatema. An organofunctionalized siloxane oligomer, which is commercially available from Evonik Operations under the trade name Dynasylan Hydrosil 2909, was provided for the production of the coating composition. The organofunctionalized siloxane oligomer was diluted with a suitable solvent to obtain a coating composition (mass fraction of siloxane oligomer about 10%), which was uniformly applied to the support layer. By evaporating the solvent (T=70° C.; t=5 min), the solid cover layer was obtained from the coating composition. For membrane E1, the coating composition was applied with an average layer thickness of approximately 22 μm. For membrane E2, the substrate produced analogously to E1 was coated again, whereby the coating composition was again applied with an average layer thickness of approximately 22 μm. For membrane E3, a one-step coating process was again selected, with the coating composition being applied with an average layer thickness of approximately 44 μm. Membrane E4 was produced largely in the same way as membrane E1, although the vacuum fixation of the coating device was dispensed with and the substrate was instead fixed with an adhesive strip in order to exclude any influence of the vacuum fixation on the infiltration of the coating composition into the substrate. The coating thickness of the cover layer in the dry state was calculated to be 2.2 μm (E1, E4) and 4.4 μm (E2, E3).

### B. Reference Membranes

The uncoated substrate, which was also used in the membranes E1 to E4, was initially used as the reference membrane V1. In addition, commercially available membranes were used as reference membranes, which are currently used in fuel cell applications, namely V2 (Nafion 110; Chemours; chemically stabilized copolymers of perfluorosulfonic acids with polytetrafluoroethylene; average thickness approx. 127 μm), V3 (Fumasep F10120-PK; Fumatech; perfluorosulfonic acid-based membrane with long side chains (LSC), reinforced with PEEK fabric; average thickness approx. 120 μm) and V4 (Fumasep F-950; Fumatech; unreinforced perfluorosulfonic acid-based membrane with long side chains (LSC); average thickness approx. 50 μm).

### C. Experiments

The water transmission rate (WTR in kilograms per square meter per day) was determined for the membranes tested. The experimental setup is based on the apparatus disclosed for this purpose in EP 2435171 B1, which comprises two fluid conduit paths Z and A separated from each other by the membrane to be tested, each with an inlet and an outlet, whereby the properties of the test gases (air) introduced into the fluid conduit paths can be controlled and the changes analyzed. In the setup used, the area of the respective membrane between the fluid conduit paths was 0.04 m², the pressure of the gases introduced into both fluid conduit paths was 200 kPa and the temperature was approximately 80° C. The first gas flow Z is dried to a humidity of approximately 0%, whereas the humidity of the second gas flow A is set to approximately 90%, which corresponds to the typical conditions of a saturated air flow for the downstream side in fuel cell applications. The volume flow of the test gases used has a considerable influence on the determined water transmission rate. As EP 2435171 B1 does not specify the volume flow rate, the volume flow rate of the test gases used was set by the inventors to Q=20 NL/min, as the inventors believe that reliable results can be obtained with this value. The measured values were each obtained as the mean value from three measurements.

The gas passage (“gas crossover”) was also determined for the selected membranes, for which the experimental setup described above only needs to be slightly adapted. Under otherwise identical conditions, the inlet of the second fluid line path is closed and the test gas is only fed through the first fluid line path (Q=70 NL/min). In this setup, the gas flow can be measured as a volume flow at the outlet of the second fluid line path.

### D. Results

The water transmission rate (WTR) was determined for the membranes according to the invention and the reference membranes as explained above. The results are summarized in Table 1.

TABLE 1

| | WTR/ |
|---|---|
| Membrane | (kg/(m² * d)) |
| V1 | 51.0 |
| E1 | 36.5 |
| E2 | 25.9 |
| E3 | 34.2 |
| E4 | 36.2 |
| V2 | 38.0 |
| V3 | 12.9 |
| V4 | 7.9 |

The data presented in Table 1 clearly show that excellent water transmission rates can be achieved with semipermeable membranes according to the invention, which are higher than with some comparable membranes from the prior art, even at higher layer thicknesses. The water transmission rates, especially when using a one-step coating process, are at a similar level to the water transmission rate of the most efficient membranes of the prior art, without having to rely on the use of perfluorosulfonic acid-based materials, so that semipermeable membranes according to the invention can represent a promising alternative to perfluorosulfonic acid-based systems without having to fear the disadvantages associated with perfluorinated ones, especially with regard to environmental and health aspects

The reference sample V1 showed an air permeability of 1.3 NL/min. The membranes according to the invention also showed an air passage of 0.01 NL/min even at the lowest coating thickness (E1), which essentially corresponds to 0% within the measurement uncertainty and is in any case significantly higher than the typical market specification of 0.5 NL/min.

In order to simulate the aging behavior, the membranes according to the invention were aged under various conditions in accordance with E1. Subsequently, the aged membranes were each examined for their water transmission rate (WTR) in comparison to the uncoated substrate. It was particularly noticeable here that no delamination of the top layer was observed in any of the ageing tests, which speaks for the excellent durability.

In ageing test A1, the samples were functionally aged, whereby the ageing conditions were adapted to the loads to be expected in a fuel cell. For this purpose, a sample vessel filled with water was sealed with the membrane and heated in an oven at 90° C. during the ageing process. As a result, the membrane experiences a constant passage of water vapor at a temperature typical for fuel cell operation. The results are summarized in Table 2.

TABLE 2

| Ageing | WTR (V1)/ | WTR (E1)/ |
|---|---|---|
| time/h | (kg/(m² * d)) | (kg/(m² * d)) |
| 48 | 104.5 | 83.0 |
| 72 | 94.9 | 80.5 |
| 96 | 101.5 | 80.1 |
| 168 | 98.6 | 79.3 |
| 192 | 111.2 | 80.9 |
| 216 | 103.2 | 81.8 |
| 240 | 100.6 | 79.3 |
| 360 | 107.4 | 94.1 |
| 384 | 111.8 | 84.6 |
| 408 | 107.7 | 89.0 |
| 432 | 115.3 | 81.8 |
| 504 | 107.3 | 84.2 |

In ageing test A2, the samples were aged at an elevated temperature of 110° C. without the presence of water vapor. The results are summarized in Table 3.

TABLE 3

| Ageing | WTR (V1)/ | WTR (E1)/ |
|---|---|---|
| time/h | (kg/(m² * d)) | (kg/(m² * d)) |
| 0 | 52 | 37 |
| 125 | 48 | 39 |
| 250 | 47 | 35 |
| 480 | 42 | 33 |
| 750 | 44 | 35 |

In the ageing test A3, the samples were stored in a boiling water bath (temperature approx. 100° C.) in order to test in particular the susceptibility to the detachment of the coating disclosed in EP 2435171 B1. The results are summarized in Table 4.

TABLE 4

| Ageing | WTR (V1)/ | WTR (E1)/ |
|---|---|---|
| time/h | (kg/(m² * d)) | (kg/(m² * d)) |
| 0 | 52 | 36.5 |
| 100 | 50 | 41 |
| 240 | 53 | 38 |

The results of the ageing tests clearly show that the advantageous water transmission rate remains guaranteed over long periods under the ageing conditions. At the same time, however, the difference in the water transmission rate compared to the uncoated substrate is maintained, so that together with the non-observed delamination of the top layer, a high durability of the coating and a very good longevity can be concluded.

The advantageous durability, even under mechanical stress, was also demonstrated by a folding test. For this purpose, a membrane was folded into a flat fold arrangement and then tested for its water transmission rate. The change in the water transmission rate from 51 (kg/(m²*d) to 54 (kg/(m²*d) is within the measurement accuracy.

### REFERENCE SIGN

10 Semipermeable membrane
12 Support layer
14 Cover layer

1. Semipermeable membrane (10), in particular for use in membrane humidifiers for fuel cell systems, comprising:
a) a support layer (12) comprising a composite material, comprising at least one plastic and at least one silicon-containing porous filler embedded in the plastic, and
b) a cover layer (14) arranged on the support layer (12), comprising at least one organosilicon compound.

2. The semipermeable membrane (10) according to claim 1, wherein the plastic is selected from the group consisting of thermoplastics, preferably selected from the group consisting of polyvinyl chlorides and polyolefins.

3. The semipermeable membrane (10) according to any of claim 1 or 2, wherein the silicon-containing porous filler is selected from the group consisting of silicon-aluminum-phosphorus-oxygen compounds, silicon-containing metal-organic framework compounds, zeolites and amorphous silicon dioxide.

4. The semipermeable membrane (10) according to any of claims 1 to 3, wherein the organosilicon compound is selected from the group consisting of silyl ethers, silanes, siloxanes and polysiloxanes.

5. The semipermeable membrane (10) according to any of claims 1 to 4, wherein at least a portion of the organosilicon compounds of the cover layer (14) is covalently bonded to the silicon-containing porous filler of the composite material.

6. The semipermeable membrane (10) according to any of claims 1 to 5, wherein the cover layer (14) has an average thickness in the range from 0.1 to 10 μm.

7. Membrane humidifier, in particular for use in fuel cell systems, comprising at least one semipermeable membrane (10) according to any of claims 1 to 6.

8. A fuel cell system, in particular a polymer electrolyte membrane fuel cell system, comprising at least one fuel cell and at least one membrane humidifier according to claim 7.

9. A method of manufacturing a semipermeable membrane (10) according to any of claims 1 to 6, comprising the method steps of:
u) Producing or providing a support layer (12) from a composite material, comprising at least one plastic and at least one silicon-containing porous filler embedded in the plastic,
v) applying a coating composition comprising at least one organosilicon compound and at least one solvent onto the surface of the support layer (12), and
w) evaporating the solvent to obtain a cover layer (14) arranged on the support layer (12), comprising at least one organosilicon compound.

10. The method according to claim 9, wherein the evaporation of the solvent is carried out in such a way that at least some of the organosilicon compounds of the cover layer (14) are covalently bonded to the silicon-containing porous filler of the composite material.
